(19) United States
(12) Patent Application Publication
(10) Pub. No.: US 2007/0104034 A1
(43) Pub. Date: May 10, 2007

(54) LCD Panel Meter for a Generator

(75) Inventors: Jere B. Albright JR., Kearney, NE (US); Jon L. Swinehart, Minden, NE (US)

Correspondence Address: LEYDIG, VOIT & MAYER, LTD.;(SEATTLE OFFICE), TWO PRUDENTIAL PLAZA, SUITE 4900, CHICAGO, IL, 60601-6731, US

(73) Assignee: POWERMATE CORPORATION, Aurora, IL (US)

(21) Appl. No.: 11/557,625

(22) Filed: Nov. 8, 2006

Related U.S. Application Data
(60) Provisional application No. 60/734,475, filed on Nov. 8, 2005.

(51) Int. Cl. G04F 10/00; G04F 8/00

(52) U.S. Cl. 368/110

(57) ABSTRACT

The LCD panel meter simultaneously displays four items: 1) power output as a percentage of the generator's continuous rated output, 2) the graphical bar that corresponds to the percentage shown in item #1, 3) a non-resettable timer displaying the total run time of the generator since manufacture, and 4) a resettable timer displaying time since last reset, intended to remind the user when to change oil or perform other maintenance.

### REFERENCE TO RELATED APPLICATIONS

This application claims priority to U.S. provisional patent application serial No. 60/734,475, filed Nov. 8, 2005, and incorporated herein by reference.

### TECHNICAL FIELD OF THE INVENTION

The present invention relates generally to generators, and more particularly to control displays for a generator.

### BACKGROUND OF THE INVENTION

A generator is a machine or device that is used to convert mechanical energy, such as that provided by the combustion of fuel, into electricity.

### SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

An embodiment provides a character-based LCD (liquid crystal display) display that is “on” whenever the generator is running. The meter simultaneously displays at least one of four items: 1) power output as a percentage of the generator's continuous rated output, 2) the graphical bar that corresponds to the percentage shown in item #1, 3) a non-resettable timer displaying the total run time of the generator since manufacture; and 4) a resettable timer displaying time since last reset, intended to remind the user when to change oil or perform other maintenance.

Other features of the invention will become apparent from the following detailed description when taken in conjunction with the drawings, in which:

### BRIEF DESCRIPTION OF THE DRAWINGS

FIG. 1 is a representation of a display in accordance with an embodiment.

### DETAILED DESCRIPTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

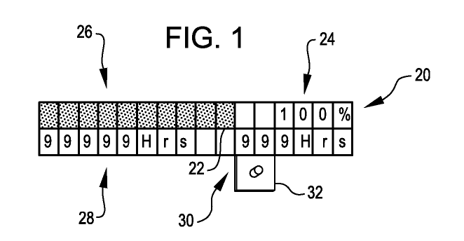

Referring now to the drawings, in which like reference numerals represent like parts throughout the several views, FIG. 1 shows a display, called an LCD panel meter 20, that may be used with a generator (not shown, but known) in accordance with an embodiment.

The LCD panel meter 20 includes a character-based LCD display 22 that is “on” when the generator is running. The LCD panel meter 20 simultaneously displays at least four items: 1) power output 24 as a percentage of the generator's continuous rated output, 2) a graphical bar 26 that corresponds to the percentage shown in item #1, 3) a non-resettable timer 28 displaying the total run time of the generator since manufacture, and 4) a resettable timer 30 displaying time since last reset, intended to remind the user when to change oil or perform other maintenance. A subset of these items may be displayed, or additional information may be displayed.

Other configurations may also be used. For example, other ways of displaying the items may be used, such as an array of LEDs (light emitting diodes) or other means of displaying information.

In an embodiment, the non-resettable timer 28 may actually be resettable (for example, by repair personnel). In such an embodiment, the resetting mechanism may be hidden from user access and/or may require a special tool that is generally available to the manufacturer and/or repair technicians. Also, the non-resettable timer 28 may track time other than “since manufacture.” As an example, the non-resettable timer 28 may track time from a particular time in the generator's life cycle, such as the time when it was rebuilt or the time when the display 20 was installed on the generator. The non-resettable timer 28 may also have the ability to be set to any particular time. For example, a replacement panel meter 20 may be set to the time on the panel meter that is being replaced.

In an embodiment, the non-resettable timer 28 and the resettable timer 30 may alternatively be shown in the same portion of the panel meter 20 and there may be a button (not shown) or other actuation mechanism for toggling between the displays of the non-resettable timer 28 and the resettable timer 30. Both timers 28, 30 count up from zero in hours, although other increments may be used.

In an embodiment, the LCD panel meter 20 has a reset button 32 to enable a user to reset the maintenance timer 30. As shown in FIG. 1, the reset button 32 is on the LCD panel meter 20 itself, but may be in other locations on a generator. For example, the button 32 may be anywhere if it is electrically, wirelessly, or otherwise connected to the device 20.

In the rear of the device, protected from user access, is a multi-pole dual in-line package (DIP) switch (not shown, but known). The DIP switch enables the factory to set each meter 28, 30 to correspond to any one of several predetermined rated power values, allowing one meter to work for many different size generators. The LCD panel meter 20 may also not have a DIP-switch and/or may also include other features.

Methods for measuring the information provide by the LCD panel meter 20 are known, but an example follows for the benefit of the reader. The LCD panel meter 20 is electrically connected to the power output winding(s) of a generator in order to power the circuits and to measure the operating voltage. Additionally, the generator power output leads are passed through a current transformer (not shown, but known) on or otherwise associated with the LCD panel meter 20 in order to measure the operating current. The product of operating current times voltage results in operating power (watts). The percent load is the result of dividing the operating power by rated power (as indicated by the DIP-switch). Meter range is 0%-100% in increments of 5% for both the numeric readout and the graphical readout. Other ranges may be used. For example, the maximum value of the meter range may exceed 100% in order to indicate when the operating power exceeds the rated operating power. In addition, the device 20 may be programmed to show 100% whenever the output power is equal to or exceeds the rated power.

These calculations, along with calculations for the two timers, are continuously updated in real time by an on-board microcontroller (not shown). This microcontroller then sends appropriate signals to drive the LCD display. Other ways for updating the calculations may be used. For example, the calculations may be updated at predetermined or other intervals. The microcontroller may round calculations to the nearest displayable value.

The microcontroller may be a standard control (i.e., a device or mechanism used to regulate or guide the operation of a machine, apparatus, or system), a microcomputer, or any other device that can execute computer-executable instructions, such as program modules. Generally, program modules include routines, programs, objects, components, data structures and the like that perform particular tasks or implement particular abstract data types. A programmer of ordinary skill in the art can program or configure the microcontroller to perform the functions described herein.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A generator comprising:
a display comprising at least one of the set of:
(a) a power output as a percentage of a rated power output of the generator;
(b) a graphical bar that corresponds to the percentage;
(c) a run time timer displaying a run time of the generator; and
(d) a resettable timer displaying the time since a last reset.

2. The generator of claim 1, further comprising a button for resetting the resettable timer.

3. The generator of claim 1, wherein the rated power output is a continuous rated output.

4. The generator of claim 1, further comprising a reset for the run time timer that requires a special tool for reset.

5. The generator of claim 1, wherein the run time timer displays total time since manufacture.

6. The generator of claim 1, wherein the set comprises:
the power output as a percentage of a rated power output of the generator; and
the graphical bar that corresponds to the percentage.

7. The generator of claim 1, wherein the set comprises:
the power output as a percentage of a rated power output of the generator; and
the run time timer displaying a run time of the generator.

8. The generator of claim 1, wherein the set comprises:
the power output as a percentage of a rated power output of the generator; and
the resettable timer displaying the time since a last reset.

9. The generator of claim 1, wherein the set comprises:
the graphical bar that corresponds to the percentage; and
the run time timer displaying a run time of the generator.

10. The generator of claim 1, wherein the set comprises:
the graphical bar that corresponds to the percentage; and
the resettable timer displaying the time since a last reset.

11. The generator of claim 1, wherein the set comprises:
the run time timer displaying a run time of the generator; and
the resettable timer displaying the time since a last reset.

12. The generator of claim 1, wherein the set comprises:
the power output as a percentage of a rated power output of the generator;
the graphical bar that corresponds to the percentage; and
the run time timer displaying a run time of the generator.

13. The generator of claim 1, wherein the set comprises:
the power output as a percentage of a rated power output of the generator;
the graphical bar that corresponds to the percentage; and
the resettable timer displaying the time since a last reset.

14. The generator of claim 1, wherein the set comprises:
the graphical bar that corresponds to the percentage;
the run time timer displaying a run time of the generator; and
the resettable timer displaying the time since a last reset.

15. The generator of claim 1, wherein the set comprises:
the power output as a percentage of a rated power output of the generator;
the run time timer displaying a run time of the generator; and
the resettable timer displaying the time since a last reset.

16. The generator of claim 1, wherein the set comprises:
the power output as a percentage of a rated power output of the generator;
the graphical bar that corresponds to the percentage;
the run time timer displaying a run time of the generator; and
the resettable timer displaying the time since a last reset.
